(19) United States
(12) Patent Application Publication
(10) Pub. No.: US 2020/0277808 A1
(43) Pub. Date: Sep. 3, 2020

(54) POWER CHILD LOCK OPERATING DEVICE

(71) Applicants: Hyundai Motor Company, Seoul (KR); Kia Motors Corporation, Seoul (KR)

(72) Inventor: Yongdae SEO, Seoul (KR)

(73) Assignees: Hyundai Motor Company, Seoul (KR); Kia Motors Corporation, Seoul (KR)

(21) Appl. No.: 16/518,817

(22) Filed: Jul. 22, 2019

(30) Foreign Application Priority Data
Feb. 28, 2019 (KR) 10-2019-0023711

(51) Int. Cl. E05B 77/32; E05B 77/26; E05B 81/06; E05B 79/20

(52) U.S. Cl. CPC E05B 77/32; E05B 77/26; E05B 81/36; E05B 79/20; E05B 81/06

(57) ABSTRACT

A power child lock operating device may include a rotating drive device; a first operation lever engaged to the rotating drive device and configured to receive a torque of the rotating drive device to be rotated; an inside handle lever configured to be connected to an inside handle mounted at a door of a vehicle to be moved together; a second operation lever configured to be connected to a door catch to lock or release the door catch; and a third operation lever selectively connecting or disconnecting the inside handle lever and the second operation lever, improving operational reliability.

### CROSS-REFERENCE TO RELATED APPLICATION

The present application claims priority to Korean Patent Application No. 10-2019-0023711 filed on Feb. 28, 2019, the entire contents of which is incorporated herein for all purposes by this reference.

### BACKGROUND OF THE INVENTION

### Field of the Invention

The present invention relates to a power child lock operating device. More particularly, the present invention relates to a power child lock operating device capable of smoothly locking and releasing a child lock provided in a rear door of a vehicle by a driver's switch operation.

### Description of Related Art

In the conventional seat of the vehicle, an inside lever for opening the door is provided. Particularly in the rear seat, a child lock device is provided to prevent a child from arbitrarily opening the door.

The child lock device is provided in a form of a knob on the inside handle so that the occupant can manually operate the knob to lock or unlock the child lock device.

In recent years, a so-called power child lock device, in which a driver locks or unlocks a child lock device by a switch operation, is universally installed to improve convenience.

A conventional power child lock device includes, a drive motor for receiving a power according to a switch operation of a driver to be operated, a worm as a drive gear provided in the drive motor, a first operation lever having a worm gear engaged with the worm, a second actuating lever having one end portion connected to the first operation lever to be integrally rotated, an unlock lever coupled to the second operation lever and connected to the door lock device, an inside handle lever connected to a door inside handle to be moved together, and a power child lock switch which is manipulated by a driver to release or lock the power child lock device, and so on.

Therefore, when the driver operates the power child lock switch in the release direction, the drive motor is supplied with power, the drive motor rotates in one direction to rotate the worm mounted at the drive motor simultaneously. The worm gear rotates the first operation lever in a clockwise direction through the worm and the second operation lever rotates clockwise by the rotation of the first operation lever to pull the unlock lever so that a power child lock device is released and the door is able to be opened.

However, if an occupant in the rear seat rotates the inside handle to open the door with a power child lock device locked and a driver simultaneously operates the power child lock switch in the release direction to release the power child lock device, the inside handle lever and the first operation lever are simultaneously operated to generate interference, so that the inside handle lever cannot return to the original position due to the interference of the first operating lever, or the releasing operation of the power child lock device is impossible, and the like.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a power child lock operating device that can operate smoothly without interfering between components, even if the rear door opening and closing operation of the vehicle occupant and the rear door opening operation of the driver are performed simultaneously.

A power child lock operating device according to an exemplary embodiment of the present invention may include, a rotating drive device; a first operation lever engaged to the rotating drive device and configured to receive a torque of the rotating drive device to be rotated; an inside handle lever configured to be connected to an inside handle mounted at a door of a vehicle to be moved together; a second operation lever configured to be connected to a door catch to lock or release the door catch; and a third operation lever selectively connecting or disconnecting the inside handle lever and the second operation lever.

The rotating drive device may be a drive motor configured to be rotatable in clockwise and anticlockwise directions.

The drive motor may be provided with a worm to be integrally rotated with the drive motor; and the first operation lever may be provided with a worm gear engaged with the worm.

One end portion of the first operation lever may be formed with the worm gear; the other end portion of the first operation lever may be provided with a pressurizing protrusion to pressurize the third operation lever; and a pin hole into which a pin is inserted may be formed between the one end portion and the other end portion so that the first operation lever can rotate.

One portion of the inside handle lever may be formed with a pin hole into which a pin is inserted; the other side thereof may be formed with a connection hole into which a cable is configured to be connected to; and a coupling groove having an open shape may be formed between the one side and the other side so that the third operation lever is selectively coupled to the coupling groove.

The second operation lever may include a pin hole into which a pin is inserted; and a coupling groove which the third operation lever is selectively coupled to.

The third operation lever may include a slot into which the pin is inserted; and a coupling protrusion inserted into and coupled to the second operation lever and selectively coupled to the coupling groove of the inside handle lever.

A return spring whose one end portion thereof is connected to the second operation lever and the other end portion thereof is connected to the third operation lever to apply an elastic restoring force to the third operation lever, may be further included.

In accordance with a power child lock operating device according to an exemplary embodiment of the present invention, a plurality of operation levers are smoothly operated without generating interference to each other so that the operating reliability may be improved, component damage or breakage due to interference of components may be effectively prevented, improving the merchantability of the vehicle.

Furthermore, it can operate smoothly without interfering between components, even if the rear door opening and closing operation of the vehicle occupant and the rear door opening operation of the driver are performed simultaneously, improving operation reliability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view in a state where a power child lock operating device according to an exemplary embodiment of the present invention is accommodated in a case.

FIG. 2 is a front view of the power child lock operating device according to an exemplary embodiment of the present invention.

FIG. 3 is a back side view of the power child lock operating device according to an exemplary embodiment of the present invention.

FIG. 4 is an exploded perspective view the power child lock operating device according to an exemplary embodiment of the present invention.

FIG. 5 is an explanatory view of operation of an inside handle lever in a state in which the power child lock operating device according to the exemplary embodiment of the present invention is released.

FIG. 6 is an explanatory diagram of operation of the inside handle lever in a state in which the power child lock operating device according to the exemplary embodiment of the present invention is locked.

FIG. 7 is an explanatory diagram of operation of releasing the power child lock operating device according to the exemplary embodiment of the present invention and simultaneous operation of the inside handle lever.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, an exemplary embodiment of the present invention will be described in detail with reference to accompanying drawings.

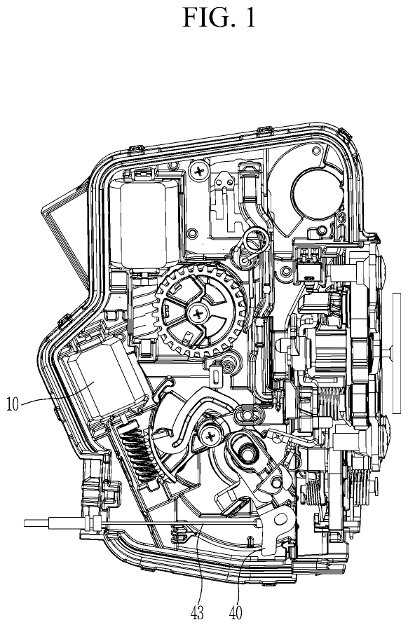

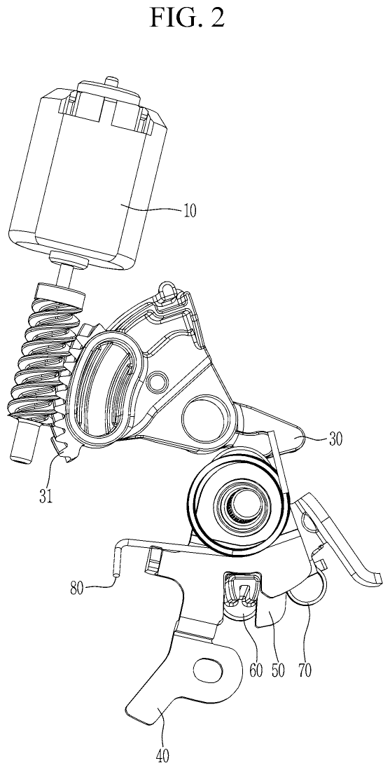

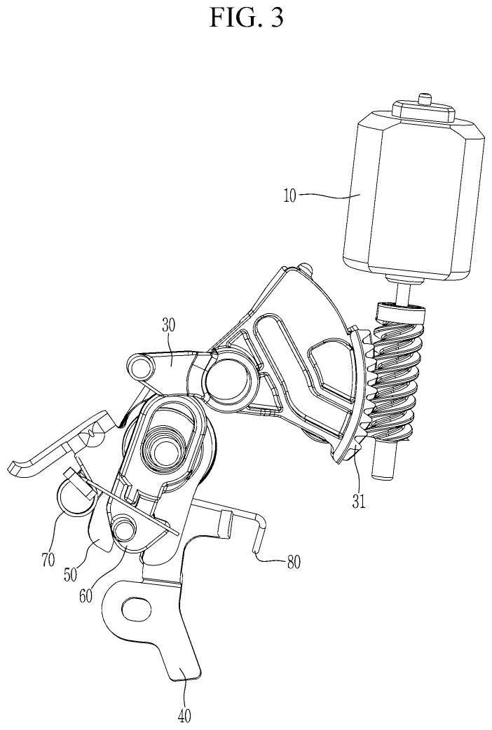

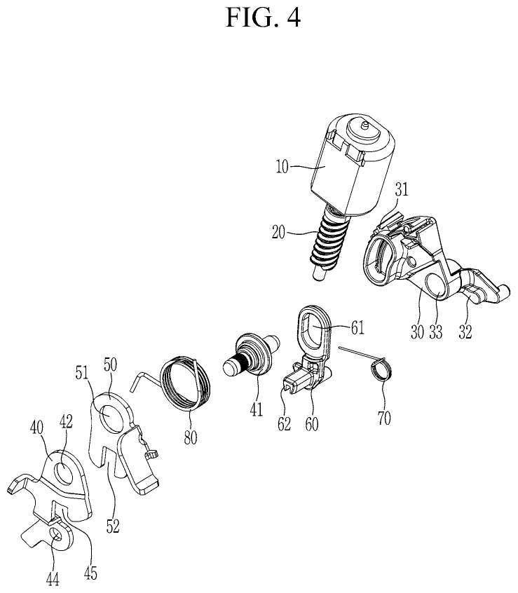

Referring to FIGS. 1 to 4, a power child lock operating device according to an exemplary embodiment of the present invention may include a drive motor 10 as a rotating drive device configured for rotating in a clockwise and anticlockwise manner, a worm 31 formed at a motor shaft of the drive motor 10, a first operation lever 30 provided with a worm gear 20 engaged with the worm 31 and configured to be rotatable, an inside handle lever 40 connected to an inside handle mounted at the door of a vehicle to be moved together and configured to be rotatable about a pin 41, a second operation lever 50 connected to a door catch for locking or releasing the door catch and configured to be rotatable about a pin 41, a third operation lever 60 which is separated from the inside handle lever 40 by being pressurized by the first operation lever 30 or coupled to the inside handle lever 40 by receiving an elastic force of a spring to return its original position, a first return spring 70 for returning the third operation lever 60 to its original position, and a second return spring 80 for returning the second operation lever 50 to its original position after the second operation lever 50 is operated to be rotated.

The first operation lever 30 may be provided with a lever body of a substantial fan shape, the lever body may be provided with the worm gear 20 at one side thereof, the other side thereof may be provided with the pressurizing protrusion 32 to be protruded, and a pin hole 33 into which the pin is inserted may be formed between the pressurizing protrusion 32 and the worm gear 20, so that the first operation lever 30 may be rotated around the pin inserted into the pin hole 33.

One portion of the inside handle lever 40 may be provided with a pin hole 42 into which the pin 41 is inserted, the other side thereof may be provided with a connection hole 44 into which a cable 43 for connecting the inside handle is inserted and connected thereto. The inside handle lever 40 may also be provided with a coupling groove 45 opened at one side thereof so that the third operation lever 60 may be inserted into and coupled thereto or separated from it.

Therefore, when a passenger operates the inside handle to open the door, the inside handle lever 40 receives the operation force of the inside handle through the cable 43 to be pulled and rotates around the pin 41.

The second operation lever 50 may be provided with a pin hole 51 into which the pin 41 is inserted and a coupling groove 52 which the third operation lever 60 is inserted into and coupled thereto.

The coupling groove 52 may be formed of an open shape at one side thereof, so that the third operation lever 60 may move along the coupling groove 52 while inserted into the coupling groove 52 and coupled to the second operation lever 50.

The second operation lever 50 may be coupled to the inside handle lever 40 through the third operation lever 60. When the inside handle lever 40 rotates with the second operation lever 50 being coupled to the inside handle lever 40 through the third operation lever 60, the second operation lever 50 rotates together to release the door catch, so that the door may be opened.

The third operation lever 60 may include a slot 61 into which the pin 41 is inserted, and a coupling protrusion 62 inserted into the coupling groove 52 of the second operation lever 50 to be coupled to the second operation lever 50 and inserted into the inside handle lever 40 to be coupled thereto or separated therefrom.

One end portion of the first return spring 70 may be connected to the second operation lever 50 and the other end portion thereof may be connected to the third operation lever 60, so that the first return spring 70 may apply an elastic force to the third operation lever 60 to return the third operation lever 60 to its original position.

The second return spring 80 may be wound around the pin 41 to apply an elastic force to the inside handle lever 40 to return the inside handle lever to its original position.

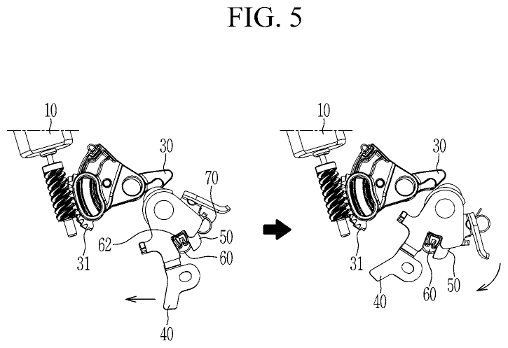

Referring to FIG. 5, with the power child lock being released, the coupling protrusion 62 of the third operation lever 60 is inserted into the coupling groove 52 of the second operation lever and the coupling groove 45 of the inside handle lever 40, respectively, so that the inside handle lever 40, the second operation lever 50 and the third operation lever 60 are integrally connected to each other.

When a passenger operates the inside handle to open the door in the instant state, the inside handle lever 40 is pulled to rotate around the pin 41 and the second operation lever 50 also rotates around the pin 41 together, so that the door catch is released by the rotation of the second operation lever 50 and the door may be opened.

When the operating force applied to the inside handle lever 40 through the inside handle is released after the door is opened, the inside handle lever 40 rotates to be returned to its original position by an elastic restoring force of the return spring 80.

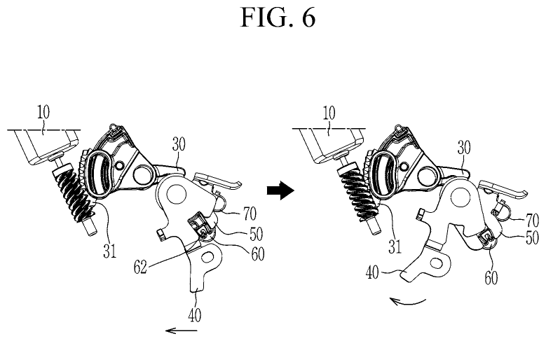

Referring to FIG. 6, with the power child lock being locked, according to the operation of the power child lock switch by the driver, the motor 10 is operated to rotate the first operation lever 30 in a clockwise direction so that the pressurizing protrusion 32 presses an upper portion of the second operation lever 50. The third operation lever 60 is pressed by the pressurizing protrusion 32 to move through the slot 61 while inserted into the pin 41, and the coupling protrusion 62 of the third operation lever 60 moves along the coupling groove 52 of the second operation lever but is not fully separated from the coupling groove 52, so that the second operation lever 50 and the third operation lever 60 maintain the coupling state each other but the second operation lever 50 is fully separated from the coupling groove 45 of the inside handle lever 40, whereby the inside handle lever 40 and the second operation lever 50 are separated from each other.

In the instant state, when a passenger operates the inside handle mounted at the door to open the door, the inside handle lever 40 is pulled and rotated around the pin 41 but as the second operation lever 50 is separated from the inside handle lever 40, the second operation lever 50 is not rotated.

Therefore, in the state where the power child lock is locked, even if the inside handle lever 40 is operated, the door is not opened.

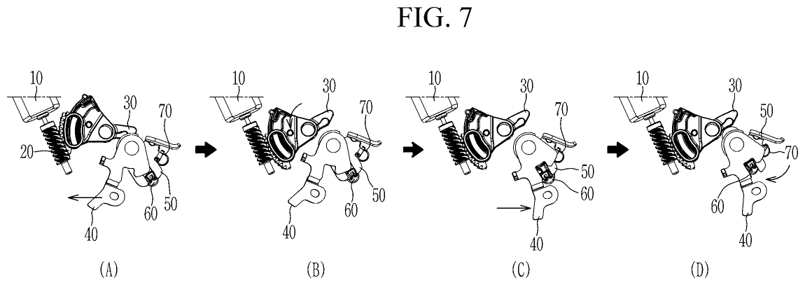

Referring to FIG. 7, when the door open operation by the passenger (inside handle operation; (A)) and the releasing operation of the power child lock by the driver (power child lock switch operation: (B)) are performed at the same time, even if the inside handle lever 40 is pulled, the door is not opened because the power child lock is released.

After the simultaneous operation is performed, when the passenger releases the inside handle, the inside handle lever 40 is returned to its original position (C), the coupling protrusion 62 of the third operation lever 60 is inserted into the coupling groove 45 of the inside handle lever 40 (D), and the second operation lever 50 is coupled to the inside handle lever 40 through the third operation lever 60, so that the door may be opened by coupling of the inside handle lever 40 and the second operation lever 50 each other when the passenger operates the inside handle again.

Conventionally, during the simultaneous operation described above, the inside handle lever 40 is interference with levers during the inside handle lever 40 is returned, but in an exemplary embodiment of the present invention, levers operate smoothly without generating interference, improving operational reliability and merchantability.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A power child lock operating device comprising:
a rotating drive device;
a first operation lever engaged to the rotating drive device and configured to receive a torque of the rotating drive device to be rotated;
an inside handle lever configured to be connected to an inside handle mounted at a door of a vehicle to be moved with the inside handle;
a second operation lever rotatably engaged to the first operation lever and configured to be connected to a door catch to lock or release the door catch; and
a third operation lever rotatably engaged to the first operation lever and selectively connecting or disconnecting the inside handle lever and the second operation lever.

2. The power child lock operating device of claim 1,
wherein the rotating drive device is a drive motor configured to be rotatable in clockwise and anticlockwise directions thereof.

3. The power child lock operating device of claim 2,
wherein the drive motor is provided with a worm to be integrally rotated with the drive motor; and
wherein the first operation lever is provided with a worm gear engaged with the worm.

4. The power child lock operating device of claim 3,
wherein a first end portion of the first operation lever is formed with the worm gear;
wherein a second end portion of the first operation lever is provided with a pressurizing protrusion to pressurize the third operation lever; and
wherein a pin hole is formed between the first end portion and the second end portion of the first operation lever so that the first operation lever is rotatable with respect to a pin coupled to the pin hole.

5. The power child lock operating device of claim 1,
wherein a first portion of the inside handle lever is formed with a first pin hole into which a pin is inserted;
wherein a second portion of the inside handle lever is formed with a connection hole into which a cable is configured to be connected to; and
wherein a first coupling groove having an open shape is formed between the first portion and the second portion of the inside handle lever so that the third operation lever is selectively coupled to the coupling groove.

6. The power child lock operating device of claim 5, wherein the second operation lever includes:
a second pin hole into which the pin is inserted; and
a second coupling groove having an open shape, wherein the third operation lever is selectively coupled to the second coupling groove.

7. The power child lock operating device of claim 6, wherein the third operation lever includes:
a slot into which the pin is inserted; and
a coupling protrusion selectively coupled to the second coupling groove of the second operation lever and selectively coupled to the first coupling groove of the inside handle lever.

8. The power child lock operating device of claim 7,
wherein a third pin hole into which the pin is inserted is formed between a first end portion of the first operation lever engaged to the rotating drive device and a second end portion of the first operation lever so that the first operation lever is rotatable with respect to the pin.

9. The power child lock operating device of claim 7, further including:
a first elastic member, wherein a first end portion of the first elastic member is connected to the second operation lever and a second end portion of the elastic member is connected to the third operation lever to apply an elastic restoring force to the third operation lever.

10. The power child lock operating device of claim 9, further including:
a second elastic member coupled to the inside handle lever.
